(19) United States
(12) Patent Application Publication
(10) Pub. No.: US 2025/0361447 A1
(43) Pub. Date: Nov. 27, 2025

(54) Method and plant for recycling carbon-containing composite materials having a carbon-containing matrix material and fibre-, filament- or wire-reinforcement

(71) Applicant: Joulmine GmbH & Co KG, Bremen (DE)

(72) Inventors: Volker LIEBEL, München (DE); Claudia Meike MARTENS, Bremen (DE)

(73) Assignee: Joulmine GmbH & Co KG, Bremen (DE)

(21) Appl. No.: 18/872,715

(22) PCT Filed: Jun. 13, 2023
(86) PCT No.: PCT/EP2023/065834

§ 371 Date: Dec. 6, 2024

(30) Foreign Application Priority Data
Jun. 13, 2022 (DE) 20 2022 001 351.5
Nov. 10, 2022 (DE) 10 2022 129 731.4

(51) Int. Cl. C10G 1/02; C01B 3/12; C10B 53/07

(52) U.S. Cl. CPC C10G 1/02; C01B 3/12; C10B 53/07; C10G 2300/1003

(57) ABSTRACT

The invention relates to a method for recycling carbon-containing composite materials having a carbon-containing matrix material and fibre-, filament- or wire-reinforcement, in particular glass-fibre- or carbon-fibre-reinforced plastics materials, GFRP/CFRP, wherein the method comprises the following steps: at least extensive separation of the reinforcement from the carbon-containing matrix material; gasifying and/or pyrolysing the carbon-containing matrix material in order to produce synthesis gases containing hydrogen and carbon monoxide or a fluid mixture containing hydrocarbons; and processing the products of the gasifying and/or the pyrolysing to form at least one, preferably liquid, fuel; wherein separating the reinforcement from the carbon-containing matrix material comprises coarse comminution of the composite material by cutting and/or crushing, fine comminution of the coarsely comminuted composite material by pressing and/or squeezing in order to release the comminuted reinforcement from the comminuted composite material, and separating the released comminuted reinforcement from the comminuted matrix material.

The invention relates to a method of recycling carbon-containing composite materials comprising carbon-containing matrix material and fiber, filament or wire reinforcement, especially glass fiber-reinforced or carbon fiber-reinforced plastics, GFRP/CFRP, and to a plant for recycling carbon-containing composite materials comprising carbon-containing matrix material and fiber, filament or wire reinforcement, especially glass fiber-reinforced or carbon fiber-reinforced plastics, GFRP/CFRP, especially for performance of the method. In particular, the invention relates to a plant and to a method for material recycling of wastes of polymeric materials, especially composite materials having polymeric components.

Composite materials having, for example, fiber, filament or wire reinforcement and a polymeric matrix material surrounding the latter are currently materially utilizable on an industrial scale only with difficulty, if at all.

Car tires, for example, are recycled in a high proportion, but are essentially utilized thermally, especially by co-combustion in plants for cement production.

An even greater problem is that of thermoset composite materials such as glass fiber-reinforced or carbon fiber-reinforced plastics (GFRP/CFRP), since the separation of reinforcement fibers and matrix material has not been achievable to date on an industrial scale.

The combustion of GFRP and CFRP is also highly problematic. The glass component of GFRP melts and drips downward, resulting in formation of glass layers that lead to plant faults. In the combustion of CFRP, by contrast, uncombusted carbon fibers get into the waste air cleaning system, where they can lead to short circuits in the electrostatic cleaning stage.

And finally, introduction into landfill is possible only to a very limited degree. In the EU, for example, only inert material may be landfilled in relatively large volumes. However, GFRP and CFRP have a very high calorific value in the order of magnitude of bituminous coal.

This situation is both an environmental problem and an economic and macroeconomic problem, and relates to a multitude of products that are produced in large numbers, for example blades and nacelle housings of wind turbines, boats and ships, shower trays and baths, pipes, shafts and tanks, components of automobiles and aircraft, and electrical technology.

In addition, in the context of the politically driven reorganisation of the fuel economy in Europe, defined in EU Directive 2018/2001 and implemented by national regulations, demand for fluid fuels produced from nonfossil sources, especially from wastes, will rise very significantly in the next few years. However, available technologies with which fluid fuels can be produced from plastics require a low proportion of inert substances. Since the fiber content at least in the case of high-quality GFRP components is generally more than 50%, GFRP is currently unavailable for this recycling pathway too.

It is thus an object of the present invention to enable recycling of carbon-containing composite materials comprising carbon-containing matrix material and fiber, filament or wire reinforcement.

This object is achieved in accordance with the invention by a method of recycling carbon-containing composite materials comprising carbon-containing matrix material and fiber, filament or wire reinforcement, especially glass fiber-reinforced or carbon fiber-reinforced plastics, GFRP/CFRP, wherein the method comprises the steps of:
at least substantially separating the reinforcement from the carbon-containing material,
gasifying and/or pyrolyzing the carbon-containing matrix material for production of hydrogen- and carbon monoxide-containing mixture, and
processing the products of the gasification and/or the pyrolysis to give a preferably fluid fuel,
wherein the separation of the reinforcement from the carbon-containing matrix material comprises coarse comminution of the composite material by cutting and/or crushing, fine comminution of the coarsely comminuted composite material by pressing and/or squeezing to part the comminuted reinforcement from the comminuted composite material, and separation of the removed comminuted reinforcement from the comminuted matrix material.

In the first plant component, the proportion of the reinforcement of fiber-, filament- or wire-reinforced carbon-containing composites is reduced and, in the third plant component, the matrix material that has been freed of the reinforcement is converted to a preferably fluid fuel.

In addition, this object is achieved by a plant or plant unit for recycling of carbon-containing composite materials comprising carbon-containing matrix material and fiber, filament or wire reinforcement, especially glass fiber-reinforced or carbon fiber-reinforced plastics, GFRP/CFRP, especially for performance of a method as claimed in any of claims 1 to 19, wherein the plant or plant unit comprises:
a first plant component for at least substantial separation of the reinforcement from the carbon-containing matrix material,
a second plant component for gasification and/or pyrolysis of the carbon-containing matrix material for production of a hydrogen- and carbon monoxide-containing synthesis gas or a hydrocarbon-containing fluid mixture, and
a third plant component for processing of the products of the gasification and/or pyrolysis to give at least one, preferably fluid, fuel,
   wherein the first plant component contains at least one cutting or crushing coarse comminution apparatus for coarse comminution of the composite material, at least one pressing and/or squeezing fine comminution apparatus for fine comminution of the coarsely comminuted composite material to part the comminuted reinforcement from the comminuted composite material, and a separation apparatus for separation of the removed comminuted reinforcement from the comminuted matrix material.

The object is also achieved by a plant or plant unit as claimed in claim 40 and a method as claimed in claim 41. Particular embodiments thereof arise from any desired combinations of claim 40 with one or more of claims 21 to 39, and from any desired combinations of claim 41 with one or more of claims 2 to 19.

In the method, it may be the case that the coarse comminution reduces the composite material to a length and/or width and/or thickness in the range from about 50 mm to about 150 mm.

Advantageously, the fine comminution comminutes the composite material to a length and/or width and/or thickness in the range from about 1 mm to about 5 mm.

Favorably, the fine comminution is conducted by means of at least one hammer mill and/or at least one grinder. This enables particularly efficient and/or inexpensive comminution.

Advantageously, heat of friction that arises in the fine comminution is removed.

In a particular embodiment, the separating is conducted by means of at least one screen and/or at least one air classifier.

Advantageously, after the separation, the matrix material includes about 5% to about 15% by weight of fibers from the reinforcement.

In a particular embodiment of the invention, the particle size of the matrix material, after sieving, is reduced, for example by grinding or beating, to max. 1500 μm, preferably max. 500 μm.

Favorably, the gasification is conducted at a process temperature in the range from preferably about 950° C. to about 1400° C. in entrained flow gasifiers, and to about 1150° C. in fixed bed gasifiers.

It may especially be the case here that the gasification is conducted at a process pressure in the range from preferably about 5 bar to about 20 bar.

In a particular embodiment, the gasification comprises a fixed bed gasification and/or fluidized bed gasification or entrained flow gasification, preferably with a liquid phase of liquid glass.

In a further particular embodiment of the present invention, the carbon monoxide produced by the gasification is transformed, preferably by steam reforming and/or water-gas shift, to a mixture of hydrogen and carbon dioxide.

It may especially be the case here that hydrogen is separated from the mixture and hence is available as fuel.

It may also be the case here that the carbon dioxide separated from the mixture is liquefied or compressed in order to facilitate transportation thereof.

In a further particular embodiment of the invention, methanol can be synthesized from the carbon monoxide and hydrogen produced by gasification by means of the exothermic reaction CO+2H₂+CH₃OH.

In addition, the invention also encompasses embodiments in which the hydrogen, preferably together with atmospheric nitrogen, is synthesized to ammonia.

The gasification process requires the supply of considerable amounts of oxygen, in the order of magnitude of 50% by weight of the material to be gasified.

As an alternative to purchasing, oxygen can appropriately be obtained from the air, especially by low-temperature rectification, pressure swing adsorption or membrane technology.

In addition, the oxygen reactant can also be partly be replaced by carbon dioxide and/or water or water vapor.

In a further particular embodiment, hydrogen and oxygen are produced by electrolysis and the oxygen produced is used as reactant in the gasification.

Favorably, at least 50% of the oxygen required for gasification is provided by the electrolysis or obtained from the air.

In accordance with the prior art, the carbon dioxide produced can be released into the atmosphere.

However, it is more environmentally favorable to capture and store the carbon dioxide, or to replace carbon dioxide that has been produced from natural gas.

For this purpose, it is also possible to provide apparatuses with which unwanted trace materials can be removed from the carbon dioxide, and apparatuses in order to be able to compress or liquefy the carbon dioxide.

In a further particular embodiment, carbon released in the division of the carbon dioxide can be synthesized to give a fluid fuel or precursors thereof, the main constituents of which are carbon and hydrogen.

In a further particular embodiment, for this purpose, the carbon dioxide separated from the mixture is split, preferably by means of oscillating electromagnetic fields, preferably where the frequency of the electromagnetic fields is about 2000 to about 3000 MHz, or electrostatic fields, preferably where the voltage of the electrostatic fields is about 20 000 V to about 50 000 V.

In the first plant component AT1, the coarse comminution apparatus may be configured to comminute composite materials to a length and/or width and/or thickness in the range from about 50 mm to about 150 mm.

Advantageously, the fine comminution apparatus is configured to comminute composite materials to a length and/or width and/or thickness in the range from about 1 mm to about 5 mm.

Appropriately, the fine comminution apparatus includes at least one hammer mill and/or at least one grinder, preferably having surfaces that move against one another and form, at least in sections, an annular gap that narrows in material flow direction.

Appropriately, the fine comminution apparatus has at least one cooling device for removal of heat of friction.

Likewise appropriately, the separation apparatus has at least one screen and/or at least one air classifier.

Advantageously, the separation apparatus is configured such that, after the separation, the matrix material includes about 5% to about 15% by weight of fibers from the reinforcement.

Advantageously, the second plant component AT2 comprises a gasification apparatus, especially wherein the process temperature thereof is about 950° C. to about 1400° C. in the case of entrained flow gasification or about 1150° C. in the case of fixed bed gasification and/or the process pressure thereof is about 5 bar to about 15 bar.

Advantageously, the gasification apparatus is designed as a fixed bed gasification apparatus or entrained flow gasification apparatus or fluidized bed gasification apparatus, preferably having a liquid phase of liquid glass.

Favorably, the third plant component AT3 contains a steam reforming apparatus and/or water-gas shift apparatus for conversion of the carbon monoxide produced in the gasification apparatus to a mixture of hydrogen and carbon dioxide or a methanol synthesis apparatus for synthesis of methanol from hydrogen and the carbon monoxide or carbon dioxide produced in the gasification apparatus.

In particular, it may be the case that the third plant component has a separation apparatus for separation of carbon dioxide from the mixture of hydrogen and carbon dioxide produced in the third plant component.

It may likewise be the case that the third plant component has a compression or liquefaction apparatus to increase the density of the separated carbon dioxide.

Advantageously, the third plant component has an ammonia synthesis apparatus for synthesis of ammonia from the hydrogen, preferably with atmospheric nitrogen.

Appropriately, the plant further comprises a further plant component having an electrolysis apparatus for production of hydrogen and oxygen by electrolysis, which is connected to the gasification apparatus for supply of the oxygen produced to the gasification.

It may also be the case that the plant or plant unit further comprises a further plant component having an atmospheric oxygen recovery apparatus for recovery of oxygen from the air, especially by means of low-temperature rectification, pressure swing adsorption or membrane technology.

In a further particular embodiment, the third plant component AT3 has a splitting apparatus for splitting of the carbon dioxide which is separated from the mixture, preferably by means of oscillating electromagnetic fields, preferably wherein the frequency of the electromagnetic fields is about 2000 to about 3000 MHz, or electrostatic fields, preferably where the voltage of the electrostatic fields is about 20 000 V to about 50 000 V.

In particular, it may be the case here that the third plant component has a fuel or precursor synthesis apparatus for synthesis of fluid fuel or precursors thereof, the main constituents of which are carbon and hydrogen, from the carbon released in the splitting of the carbon dioxide.

Advantageously, the plant or plant unit is configured such that 50% of the oxygen required by the gasification apparatus is provided by the electrolysis apparatus or the atmospheric oxygen recovery apparatus.

Advantageously, the function of at least one of the plant components is integrated in another of the plant components.

Finally, it may be the case that the plant components are installed not in spatial proximity but separately from one another, including at different sites.

The basis of the present invention, which is the result of extensive process development, is the surprising finding that the specific manner of separation, more particularly for the first time, enables gasification in a stable and reliable process.

At least in a particular embodiment, particularly efficient and/or inexpensive comminution is enabled.

Moreover, at least in a particular embodiment, a robust and procedurally reliable combination of machines for separation of the reinforcement from the carbon-containing matrix material is provided.

Moreover, at least in a particular embodiment, the carbon dioxide produced is split into hydrocarbons and oxygen, where the oxygen covers the entire demand of the gasification and the hydrocarbons can be used as fuels or for production of fuels.

Further features and advantages of the invention will be apparent from the claims and the description of particular working examples that follows, with reference to the schematic drawings. The figures show:

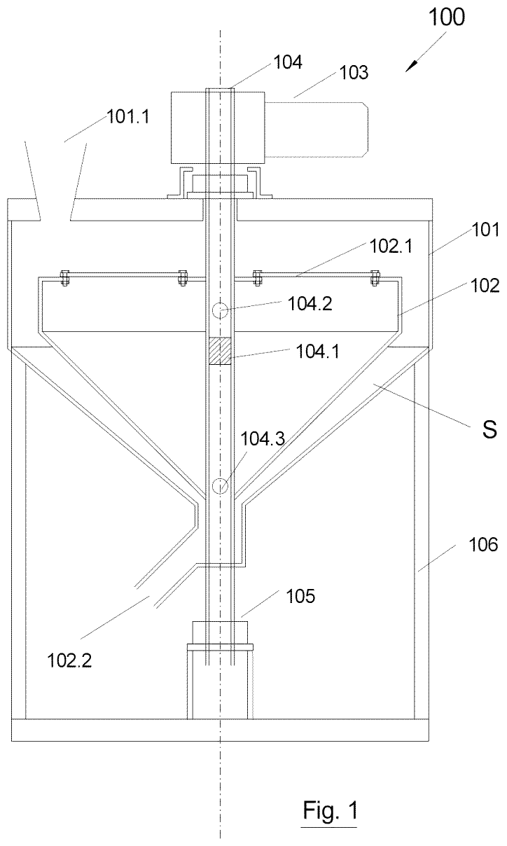

FIG. 1 a vertical section view of a grinder of a plant in a particular embodiment of the present invention;

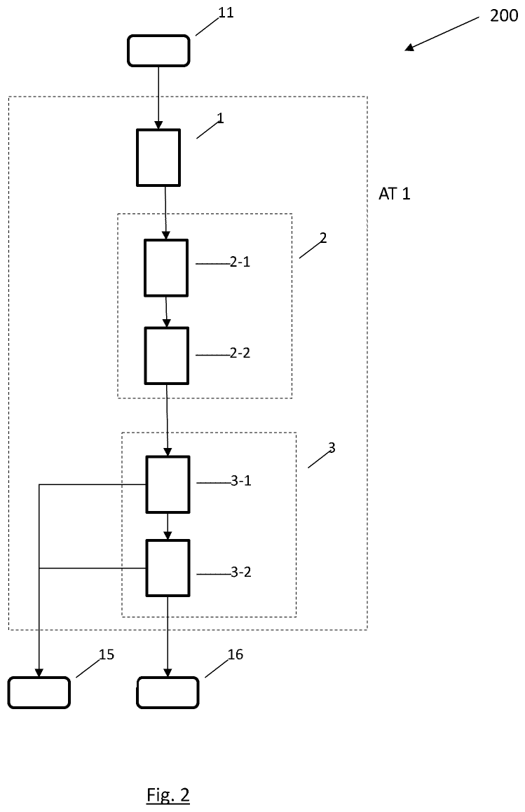

FIG. 2 a schematic of components of a first plant component of a plant in a particular embodiment of the present invention;

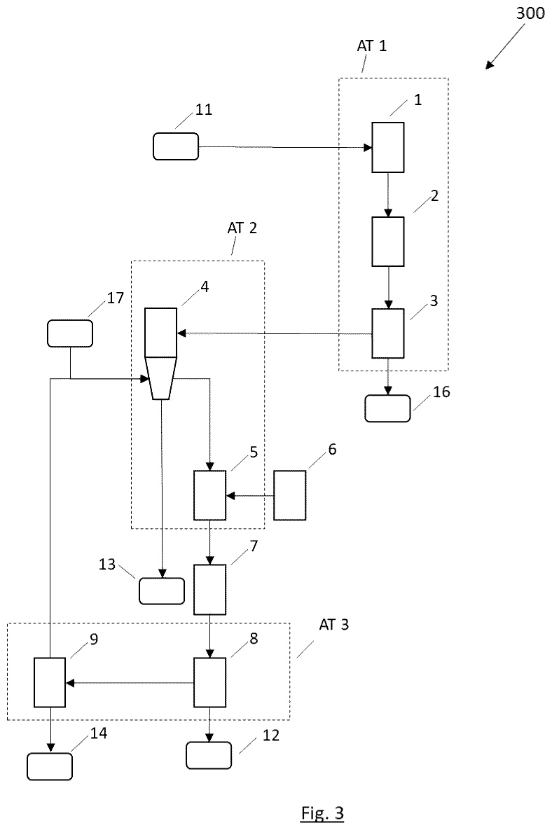

FIG. 3 a schematic of a plant having a gasification apparatus in a further particular embodiment of the present invention;

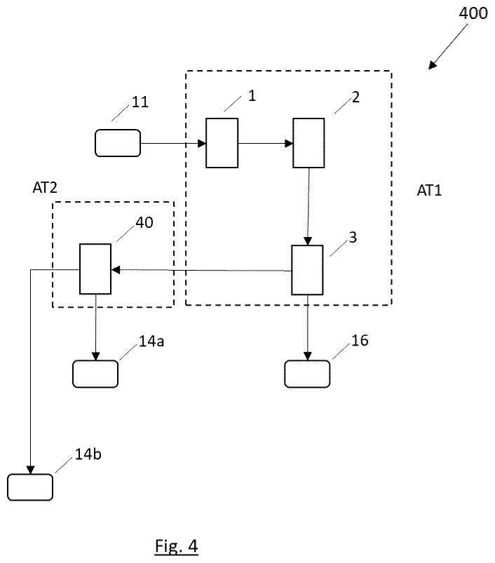

FIG. 4 a schematic of a plant having a pyrolysis apparatus in a further particular embodiment of the present invention; and

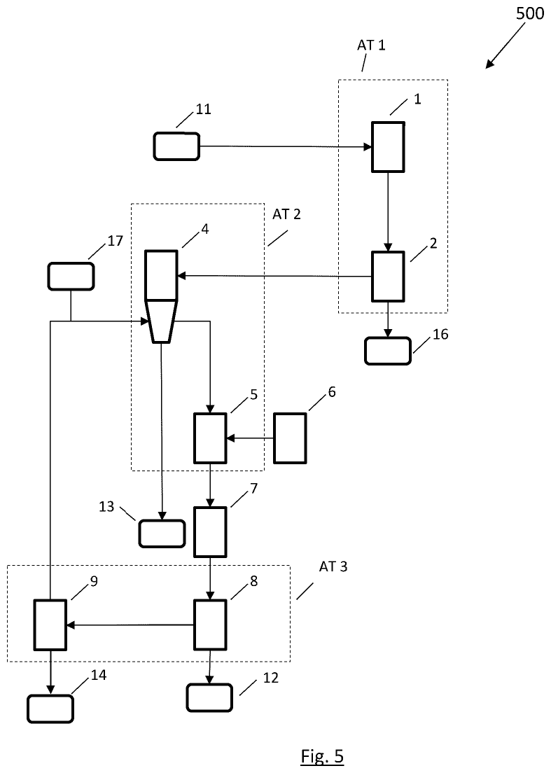

FIG. 5 a schematic of a plant having a gasification apparatus in a further particular embodiment of the present invention.

In a plant or plant unit according to a particular embodiment of the present invention, in a first plant component, carbon-containing composite materials, in this example fiber composite materials, from component parts are separated substantially into fibers or filaments and pulverulent and granular matrix material.

For this purpose, the component parts to be recycled are first disassembled manually to such an extent that they are smaller than the receiving opening of a coarse comminution apparatus that forms part of the first plant component. In an advantageous embodiment of the invention, the receiving opening has a width of about 2 m to about 2.5 m and a height of about 1 m to about 2 m.

The manual disassembly is preferably effected with saws, especially circular saws, water-jet cutting devices and hydraulic tongs. The advantage of water-jet cutting devices over saws lies in reduced production of dust and much lower noise. It is also possible here, for example, to remove metallic components of the component parts, such as frames, flanges etc., in order that these cannot damage or cause excessive wear to a downstream comminution apparatus that is likewise part of the first plant component.

The component parts are then cut or crushed in the coarse comminution apparatus to a size that can be accepted by the downstream fine comminution apparatus. This size is advantageously between about 50 mm and about 150 mm. The power consumption of the comminution apparatus can become too high if the size is less than about 50 mm, and that of the downstream fine comminution apparatus if it is more than about 150 mm.

The coarse comminution apparatus may include two or more coarse comminution apparatuses or machines. These may be designed, for example, as a single- or twin-shaft machines and preferably be equipped with overload protection with reversing operation in order to avoid damage to the coarse comminution apparatuses or machines. Alternatively or additionally, preference is given to the use of a coarse comminution apparatus or machine, the products of which are of very substantially uniform size.

The coarse comminution apparatus may include two or more coarse comminution apparatuses or machines of different design. For example, it is possible to combine crushers and/or comminution machines and/or hammer mills and/or crossflow shredders.

In the fine comminution apparatus, there is at least substantial separation of the comminuted, still fiber-reinforced components into reinforcement and matrix material. For this purpose, the material, rather than being cut or crushed, is pressed or squeezed, which loosens and parts the bond between the reinforcement and the matrix material.

The fine comminution apparatus may also include multiple fine comminution apparatuses or machines of identical different design, especially hammer mills and grinders.

Suitable fine comminution apparatuses include hammer mills and grinders. In the case of hammer mills, the size of the matrix material present after the comminution process can be adjusted, for example, via the distance of the hammers from the screen basket and the perforation size of the screen basket.

Grinders, which preferably have a narrowing gap at least in sections, where the elements of the grinder that form the gap can move against one another, in order to increasingly comminute the still fiber-reinforced components in this narrowing gap, are of particularly good suitability. Advantageously, the gap is formed, for example, from two frustocones. This construction preferably has gap walls that are smooth at least in the last region, which means that comminution takes place only between the fiber-reinforced composite material elements, in order to achieve separation of fibers, filaments or wires from the carbon-containing matrix material while conserving the fiber, filament or wire length. The basic form of such a grinder is shown by way of example, but without restricting the scope of the invention, in EP000002288452B1.

In such a grinder, either the inner or outer frustocone may be the stator, and the other may be the rotor.

The axes of the frustocones may be identical, but they may also be shifted in parallel with respect to one another and/or have an angle to one another.

Advantageously, the surfaces of the frustocones where the grinding takes place are made from particularly tough and abrasion-resistant material, preferably with at least HBW500. In a preferred embodiment, the surfaces of the frustocones where the grinding takes place are exchangeable.

The surfaces of the frustocones where the grinding takes place may be smooth and also at least partly structured.

The axes of the frustocones preferably have an angle between 30° and 90° to the horizontal, where the angle between the inside of the outer frustocone at its lowermost position relative to the horizontal is preferably greater than 0°, in order to assist material flow.

An advantageous embodiment of the grinders has devices for removing the heat that arises in the grinding operation. In the simplest embodiment, these comprise cooling fins that are preferably designed on the moving part of the grinder so as to achieve a maximum amount of forced convection. On the fixed part in particular, forced convection can also or additionally be achieved with a fan.

Heat can also be removed, for example, by means of cooling water. Options for this purpose in the case of the fixed element are pipe coils secured to the wall, or cooling water ducts running within the wall. Especially in the case of the moving part, it may be advantageous also to introduce or apply cooling water by spraying. If the grinder is not installed in a frost-protected area, the cooling water should advantageously be provided with an antifreeze additive.

The product of the grinder in this example is a mixture of glass fibers and pulverulent or granular matrix material.

FIG. 1 shows a grinder 100 of a first plant component AT1 (see, for example, FIG. 2) of a plant for recycling of carbon-containing composite materials comprising carbon-containing matrix material and fiber, filament or wire reinforcement according to a particular embodiment of the present invention.

The grinder 100 comprises a frame 106, a stator 101 which is conical in the lower region and is mounted in the frame 106, and a rotor 102 which is likewise conical in the lower region, where the frustocones of the stator and rotor form an annular gap S that narrows in the downward direction.

The rotor 102 is driven by a motor, for example a drive motor 103, via a shaft, for example a hollow shaft 104, which is mounted in the drive motor 103 and a bearing, for example a thrust bearing 105. The lumen of the hollow shaft 104 in this example is blocked at a site 104.1, and in this example has two openings 104.2 and 104.3. This means that the rotor can be cooled in that water, for example, is admitted as cooling water into the upper opening 104.2 of the hollow shaft 104.

The rotor 102 in this example has multiple inspection openings 102.1 and may have devices, for example guide plates or spray nozzles, with which the cooling water is distributed and hence heat transfer is improved.

The precomminuted composite materials are fed to the grinder 100 via a feed opening 101.1. The composite materials are ground in the narrowing conical annular gap S between the stator 101 and the rotor 102, and leave the grinder 100 via a release opening 101.2.

Further inventive embodiments of the fine comminution apparatus comprise, for example, ball mills or hammer mills.

In a separation apparatus downstream of the grinder, in this example, the glass fibers may be separated from the matrix material. Complete separation is not required here; a reduction in the glass fiber content from originally 50-60%, for example, to 5-15%, for example, is generally sufficient for undisrupted further use of the material in the second plant component of a plant according to a particular embodiment of the present invention.

A preferred separation method is screening. A prerequisite for screening is that the majority of the fibers are longer than the diameter of the pulverulent or granular matrix material. Preferably at least 90% by weight of the fibers has a length greater than the diameter of 90% by weight of the matrix material.

Since the density of glass is more than twice as high as that of the polymeric matrix material, it is also possible to use air classifiers, for example, to achieve a high degree of separation at high throughput.

A separation apparatus may also consist, for example, of a combination of different screening systems and air classifiers.

FIG. 2 shows a schematic of components of a first plant component AT1 of a plant 200 in a particular embodiment of the present invention.

The first plant component, in which the proportion of the reinforcement of the fiber-, filament- or wire-reinforced carbon-containing composite materials is reduced, comprises a coarse comminution apparatus 1, a fine comminution apparatus 2 and a separation apparatus 3. Component parts made from composite materials 11, the dimensions of which may be several meters, for example, are crushed or comminuted in the coarse comminution apparatus 1. Depending on downstream devices, the components may preferably be comminuted to a size of about 50 mm to about 800 mm. In this working example, the coarse comminution apparatus 1 comprises only one coarse comminution apparatus or machine.

The fine comminution apparatus 2 in this example comprises a hammer mill 2-1 and a grinder 2-2. In the hammer mill 2-1, the bond between the glass fibers 16 and the matrix material 15 in this example is loosened. The two fractions are then separated in the grinder 2-2.

The separation apparatus 3 in this example comprises an air classifier 3-1, in which a portion of the matrix material 15 is separated off, and a screen or screen device 3-2 in which the remaining material is separated very substantially into matrix material 15 and glass fibers 16.

The connections between the fine comminution apparatus 2 and the separation apparatus 3 are preferably closed, in order to prevent the spread of dust. This is also true of the connection of the screen device 3-2 to any storage devices for the glass fibers and the pulverulent matrix material in this example.

The first plant component preferably has air suction and filter systems and/or anti-explosion and fire-extinguishing devices and/or is preferably installed spatially separately from other plant components, for example in a separate hall.

A pelletizing apparatus is preferably (also) provided in order to reduce the risk of dust explosions of the pulverulent matrix material, and/or to simplify the transport and further processing thereof.

In a third plant component (not shown in FIG. 2), fluid fuels are produced from the products from the first plant component.

Preferably, a second plant component (not shown in FIG. 2), which is connected downstream of the first plant component and upstream of the third plant component, has a pyrolysis apparatus for production of predominantly liquid hydrocarbons or a gasification apparatus for production of a synthesis gas with hydrogen and carbon monoxide as its main constituents.

The gasification apparatus may be designed, for example, for continuous and/or batchwise operation.

In the case of a design for batchwise operation, quasi-continuous operation can be achieved in that the plant has multiple gas generation units with which time-delayed operation and material cycling is enabled.

Continuous apparatuses for synthesis gas production are advantageous since they facilitate the process operation of the downstream apparatuses. Useful embodiments have been found to be those as described by way of example in EP2639289A1.

The gasification temperature is advantageously about 1000° C. to about 1100° C., since the greatest level of hydrogen production takes place in this range.

The gasification pressure is preferably about 5 bar to about 20 bar. Although hydrogen production would be somewhat higher at ambient pressure, it would be necessary to process and compress greater gas volumes in the subsequent process steps, which would reduce overall efficiency.

In principle, it is possible to use either fluidized bed gasification or fixed bed gasification, for example. Fixed bed gasification enables a more stable process, especially in the case of fluctuating quality and variable size of the input materials. In addition, fixed bed gasification enables the inclusion of nearly all by-products in a vitrified and hence extremely inert slag.

In this example, fixed bed gasification with a liquid glass phase as the fixed bed is particularly advantageous. In that case, remaining glass fiber components in the products from the first plant components are actually advantageous because they replace the addition of glass which is otherwise required to maintain the liquid glass phase.

It is also possible to provide plasma gasification. This has the advantage that, because of the high process temperatures exceeding 3000° C., the synthesis gas barely has any constituents of relatively high molecular weight. Disadvantages are the lower hydrogen concentration in the synthesis gas and the very high power demand.

Also advantageous is a combination of a gasification apparatus having process temperatures up to 1500° C. with a downstream plasma gasification having temperatures exceeding 2000° C. This increases hydrogen production and reduces power demand compared to straight plasma gasification.

In a third plant component, in a particular embodiment, the hydrocarbon-containing mixture from the pyrolysis apparatus is synthesized to the desired end products. Preferably, carbon monoxide present in the synthesis gas is used to produce methanol (CO+H₂→CH₃OH) or, by steam reforming (water-gas shift reaction), further hydrogen and carbon dioxide (CO+H₂O→CO₂+H₂).

The second and/or third plant component advantageously has apparatuses for cooling and/or purifying the gases to remove unwanted or toxic components. Depending on the loading of the synthesis gas, for example, an air filter and/or water scrubber may be sufficient. In the case of contamination with sulfur, chlorine, etc., it may be necessary to use chemical or absorption/adsorption filter systems, for example.

In the third plant component, if required, a produced gas mixture may be separated and the produced fluid fuel may be released. A hydrogen-carbon dioxide mixture may in principle be separated by any available technology, for example membrane, absorption and adsorption devices. If the gas mixture is at elevated pressures, one option in particular is membrane separation devices, because the main expenditure therein is in the compression of the gas mixture to about 10 bar, and this can be at least greatly reduced.

In the simplest case, the hydrogen can be released, for example, by means of a compressor station that feeds the hydrogen produced into a conduit. This plant component may alternatively contain components for storage of the fuel and optionally for liquefaction thereof.

The third plant component may also include an ammonia synthesis apparatus in which hydrogen produced is transformed to ammonia with atmospheric nitrogen (for example by means of a Haber-Bosch process), in order to transform it to a more easily transportable and storable fuel.

The plant may also include a plant component in which waste heat from other plant components can be collected and provided as process heat. Given an appropriate temperature level, it is also possible to generate power, for example by means of a generator coupled to a steam turbine.

State of the art in gasification plants is the release of the carbon dioxide produced to the atmosphere. In a particular embodiment of the present invention, by contrast, the carbon dioxide is processed for further uses. This may include components by means of which carbon dioxide produced can be compressed or liquefied and hence provided for replacement of fossil-produced carbon dioxide.

In addition, it may be the case that the plant has one or more components in order to produce oxygen for supply of the gasification plant. This advantageously involves using an electrolyzer, since the hydrogen obtained then further increases the total hydrogen production of the plant:

The gasification of, for example, 22 000 t of plastic requires about 11 500 t of oxygen. This produces 3000 t of hydrogen. If this 11 500 t of oxygen is obtained by electrolysis, a further 1275 t of hydrogen is formed.

In a particular embodiment, it is also possible to provide at least one atmospheric oxygen recovery method for recovery of oxygen from the atmosphere, for example low-temperature rectification, pressure swing adsorption or membrane technology.

The production of the oxygen for supply of the gasification apparatus from the carbon dioxide produced is particularly advantageous.

A preferred embodiment of the plant for this purpose includes apparatuses for splitting the carbon dioxide into carbon and oxygen and for synthesizing the carbon to hydrocarbons that can be processed further, for example, in a refinery to give commercial fuels and raw materials for the chemical industry.

The separation apparatuses for separation of the carbon dioxide preferably have elements for generation of oscillating electromagnetic or electrostatic fields which assist the splitting of the C—O double bonds.

The preferred frequency of the electromagnetic fields is about 200 to about 3000 MHz. The preferred voltage in the case of electrostatic fields is preferably about 20 000 to about 50 000 V.

The carbon dioxide produced in a gasification apparatus according to the prior art is nearly twice the mass of the carbon-containing materials to be gasified. The oxygen content in the carbon dioxide is 16 forty-fourths of its mass, i.e. 32 forty-fourths of the mass of the carbon-containing materials to be gasified and hence much more than the oxygen demand of the gasification apparatus, which means that the objective of covering the entire oxygen demand of the gasification is met.

FIG. 3 shows a schematic of a plant 300 having a gasification apparatus 4 in a further particular embodiment of the present invention. For the sake of clarity, there is no depiction of, for example, pumps/compressors, throttle devices, heat transferers, conveying devices, buffer storage means etc.

In a first plant component AT1, comminuted, previously manually divided composite materials 11 are fed from a coarse comminution apparatus 1 as described above, for example, with reference to FIGS. 1 and/or 2, through a fine comminution apparatus 2 as described above, for example, with reference to FIGS. 1 and/or 2, and a separation apparatus 3 as described above, for example, with reference to FIGS. 1 and/or 2, to a gasification apparatus (gasifier) 4 in a second plant component AT2. Glass fibers 16 are separated off in the separation apparatus 3. A synthesis gas produced in the gasification apparatus 4 with a supplied reactant 17 is fed to a steam reforming apparatus (steam reformer) 5; slag 13 is drawn off. The reactant 17 may especially include oxygen, carbon dioxide and/or water (vapor). In the steam reformer 5, the CO content of the synthesis gas produced in the gasification apparatus 4 is synthesized to H₂ and CO₂ with the aid of steam produced in a steam generator 6. In a cleaning plant 7, the synthesis gas can be cleaned and, if required, cooled. In a separation apparatus 8, the H₂/CO₂ mixture is separated, i.e. hydrogen 12 is recovered. In a splitting apparatus 9 in a third plant component AT3, the remaining CO₂ is split into oxygen and carbon, and hydrocarbons are synthesized. The hydrocarbons can be utilized as fuel or as a precursor therefor, and oxygen is metered to the gasifier 4 in this example.

FIG. 4 shows a schematic of a plant 400 having a pyrolysis apparatus 40 in a further particular embodiment of the present invention. For the sake of clarity, there is no depiction of, for example, pumps/compressors, throttle devices, heat transferers, conveying devices, buffer storage means and cooling and cleaning devices etc.

In a first plant component AT1, comminuted, previously manually divided composite materials 11 are fed from a coarse comminution apparatus 1 as described above, for example, with reference to FIGS. 1 and/or 2 and/or 3, through a fine comminution apparatus 2 as described above, for example, with reference to FIGS. 1 and/or 2 and/or 3, and a separation apparatus 3 as described above, for example, with reference to FIGS. 1 and/or 2 and/or 3, to the pyrolysis apparatus (pyrolysis reactor) 40 in a second plant component AT2. Glass fibers 16 are separated off in a separation apparatus 3.

In the pyrolysis apparatus 40, liquid hydrocarbons 14a and gaseous hydrocarbons 14b are produced.

FIG. 5 shows a further particular embodiment of an inventive plant 500. In a first plant component AT1, previously manually divided composites 11 are fed to a coarse comminution apparatus 1 in which the matrix material is parted from the glass fiber weave by beating while largely conserving the glass fiber weave.

The parted matrix material is then comminuted in a fine comminution apparatus 2 to a grain size of not more than, for example, 1.5 mm, preferably, for example, 0.5 mm. In a second plant component AT2, this pulverulently ground matrix material is fed to an entrained flow gasifier in which hydrogen- and carbon monoxide-containing synthesis gas is produced.

A synthesis gas produced in a gasification apparatus 4 with a supplied reactant 17 is fed to a steam reforming apparatus (steam reformer) 5; slag 13 is drawn off. The reactant 17 may especially include oxygen, carbon dioxide and/or water (vapor). In the steam reformer 5, the CO content of the synthesis gas produced in the gasification apparatus 4 is synthesized to H₂ and CO₂ with the aid of steam produced in a steam generator 6. In a cleaning plant 7, the synthesis gas can be cleaned and, if required, cooled. In a separation apparatus 8, the H₂/CO₂ mixture is separated, i.e. hydrogen 12 is recovered. In a splitting apparatus 9 in a third plant component AT3, the remaining CO₂ is split into oxygen and carbon, and hydrocarbons are synthesized. The hydrocarbons can be utilized as fuel or as a precursor therefor, and oxygen is metered to the gasifier 4 in this example.

The above-described plant components may be installed in spatial proximity, or else separately from one another, including at separate sites.

The features of the invention as disclosed in the present description, in the drawings and in the claims may be essential to the implementation in its various embodiments either individually or in any desired combinations.

List of reference numerals

| | |
|---|---|
| 1 | coarse comminution apparatus |
| 2 | fine comminution apparatus |
| 2-1 | hammer mill |
| 2-2 | grinder |
| 3 | separation apparatus |
| 3-1 | air classifier |
| 3-2 | screen device |
| 4 | gasification apparatus |
| 5 | steam reformer |
| 6 | steam generator |
| 7 | cleaning plant |
| 8 | separation apparatus |
| 9 | splitting apparatus |
| 11 | composite material |
| 12 | hydrogen |
| 13 | slag |
| 14a | liquid hydrocarbons |
| 14b | gaseous hydrocarbons |
| 15 | matrix material |
| 16 | glass fibers |
| 17 | reactant |
| 40 | pyrolysis apparatus |
| 100 | grinder |
| 101 | stator |
| 101.1 | feed opening |
| 101.2 | release opening |
| 102 | rotor |
| 102.1 | inspection openings |
| 103 | drive motor |
| 104 | hollow shaft |
| 104.1 | site |
| 104.2 | opening |
| 104.3 | opening |
| 105 | thrust bearing |
| 106 | frame |
| 200 | plant |
| 300 | plant |
| 400 | plant |
| 500 | plant |
| AT1 | first plant component |
| AT2 | second plant component |
| AT3 | third plant component |
| S | annular gap |

1. A method of recycling carbon-containing composite materials comprising carbon-containing matrix material and fiber or filament reinforcement, wherein the method comprises the steps of:
at least substantially separating the reinforcement from the carbon-containing material;
gasifying and/or pyrolyzing the carbon-containing matrix material for production of hydrogen- and carbon monoxide-containing synthesis gas or a fluid mixture containing hydrocarbons; and
processing the products of the gasification and/or the pyrolysis to give a preferably fluid fuel;
wherein the separation of the reinforcement from the carbon-containing matrix material comprises coarse comminution of the composite material by cutting and/or crushing, fine comminution of the coarsely comminuted composite material by pressing and/or squeezing to part the comminuted reinforcement from the comminuted composite material, and separation of the removed comminuted reinforcement from the comminuted matrix material;
wherein the fine comminution is conducted by means of at least one hammer mill and/or at least one grinder having surfaces that move against one another and form, at least in sections, an annular gap S that narrows in material flow direction.

2. (canceled)

3. (canceled)

4. (canceled)

5. The method of claim 1, wherein heat of friction that arises in the course of fine comminution is removed.

6. The method of claim 1, wherein the separating is conducted by at least one screen and/or at least one air classifier.

7. The method as claimed in of claim 1, wherein, after the separation, the matrix material includes about 5% to about 15% by weight of fibers from the reinforcement.

8. The method of claim 1, wherein the gasification is conducted at a process temperature in the range from preferably about 950° C. to about 1400° C. in entrained flow gasifiers, and to about 1150° C. in fixed bed gasifiers.

9. (canceled)

10. (canceled)

11. The method of claim 1, wherein the carbon monoxide produced by the gasification is transformed, preferably by steam reforming and/or water-gas shift, to a mixture of hydrogen and carbon dioxide.

12-19. (canceled)

20. A plant or plant unit for recycling of carbon-containing composite materials comprising carbon-containing matrix material and fiber, filament or wire reinforcement, wherein the plant or plant unit comprises:
a first plant component AT1 for at least substantial separation of the reinforcement from the carbon-containing matrix material;
a second plant component AT2 for gasification and/or pyrolysis of the carbon-containing matrix material for production of a hydrogen- and carbon monoxide-containing synthesis gas or a fluid mixture containing hydrocarbons; and
a third plant component AT3 for processing of the products of the gasification or pyrolysis to give at least one fuel;
wherein the first plant component AT1 contains at least one cutting or crushing coarse comminution apparatus for coarse comminution of the composite material, at least one pressing or squeezing fine comminution apparatus for fine comminution of the coarsely comminuted composite material to part the comminuted reinforcement from the comminuted composite material, and a separation apparatus for separation of the removed comminuted reinforcement from the comminuted matrix material.

21. The plant or plant unit of claim 20, wherein the coarse comminution apparatus is configured to comminute composite materials to a length and/or width and/or thickness in the range from about 50 mm to about 150 mm.

22. The plant or plant unit of claim 20, wherein the fine comminution apparatus is configured to comminute composite materials to a length and/or width and/or thickness in the range from about 1 mm to about 5 mm.

23. (canceled)

24. The plant or plant unit of claim 20, wherein the fine comminution apparatus has at least one cooling device for removal of heat of friction.

25. The plant or plant unit of claim 20, wherein the separation apparatus has at least one screen and/or at least one air classifier.

26. (canceled)

27. The plant or plant unit of claim 20, wherein the second plant component AT2 has a gasification apparatus, especially wherein the process temperature thereof is about 950° C. to about 1400° C. in the case of an entrained flow gasifier, or to about 1150° C. in the case of fixed bed gasifiers, and/or the process pressure thereof is about 5 bar to about 20 bar.

28. (canceled)

29. The plant or plant unit of claim 27, wherein the third plant component AT3 contains a steam reforming apparatus and/or water-gas shift apparatus for conversion of the carbon monoxide produced in the gasification apparatus to a mixture of hydrogen and carbon dioxide or a methanol synthesis apparatus for synthesis of methanol from hydrogen and the carbon monoxide or carbon dioxide produced in the gasification apparatus.

30. The plant or plant unit of claim 29, wherein the third plant component AT3 has a separation apparatus for separation of carbon dioxide from the mixture of hydrogen and carbon dioxide produced in the third plant component AT3.

31-35. (canceled)

36. The plant or plant unit of claim 30, wherein the third plant component AT3 has a splitting apparatus for splitting of the carbon dioxide is separated from the mixture.

37. The plant or plant unit of claim 36, wherein the third plant component AT3 has a fuel or precursor synthesis apparatus for synthesis of fluid fuel or precursors thereof, the main constituents of which are carbon and hydrogen, from the carbon released in the splitting of the carbon dioxide.

38. The plant or plant unit of claim 20, wherein the function of at least one of the plant components is integrated in another of the plant components.

39. The plant or plant unit of claim 20, wherein the plant components are installed not in spatial proximity but separately from one another, including at different sites.

40-41. (canceled)

42. The plant or plant unit of claim 30, wherein the third plant component AT3 has a splitting apparatus for splitting of the carbon dioxide is separated from the mixture by means of oscillating electromagnetic fields or electrostatic fields.

43. The plant or plant unit of claim 30, wherein the third plant component AT3 has a splitting apparatus for splitting of the carbon dioxide is separated from the mixture by means of oscillating electromagnetic fields wherein the frequency of the electromagnetic fields is about 2000 to about 3000 MHz, or electrostatic fields wherein the voltage of the electrostatic fields is about 20 000 V to about 50 000 V.
